(19) United States
(12) Patent Application Publication
(10) Pub. No.: US 2005/0172490 A1
(43) Pub. Date: Aug. 11, 2005

(54) Double-sided and single-sided shearing devices including ridges

(76) Inventor: Wai-Wah Yiu, Hong Kong (CN)

Correspondence Address: JONES DAY, 222 EAST 41ST ST, NEW YORK, NY, 10017, US

(21) Appl. No.: 11/025,338

(22) Filed: Dec. 29, 2004

Related U.S. Application Data
(63) Continuation-in-part of application No. 10/748,037, filed on Dec. 29, 2003.

(51) Int. Cl. B26B 19/00

(52) U.S. Cl. 30/34.1

(57) ABSTRACT

A shearing device is provided for such applications as trimming hair in the nose. The shearing device includes a housing having a top portion and a bottom portion, where the top portion has at least one opening and a plurality of ridges that form channels adjacent to the at least one opening. At least one cutting blade assembly is disposed in each of the openings in the top portion of the housing of the shearing device. Each cutting blade assembly includes one or more blade members. The top portion of the shearing device includes a plurality of ridges that bracket the cutting teeth of the blade members on the cutting blade assembly. The plurality of ridges form channels that expose the teeth of the trimmer blade members, and space the teeth on the blade members of the device away from the skin. The length of the hairs remaining after cutting is determined by the depth of the channels formed by the ridges. In one embodiments of the invention, the cutting head of the shearing device includes a single opening, and a single cutting blade assembly. In another embodiment, the shearing device is a double-sided shearing device, which includes two openings located on opposite sides of the cutting head, and two sets of cutting blade assemblies.

### FIELD OF INVENTION

This invention relates to a shearing device with safety strips that space the cutting blades of the shearing device a distance from a surface to prevent damage to the surface during operation.

### BACKGROUND OF THE INVENTION

There are many varieties of compact electric facial trimmers available on the market for removal of facial hair. In many instances, the compact electric facial trimmers are sold with attachments that space the blades of the trimmer from the skin, and cause the facial hair to be safely trimmed to a desired length. Such attachments are typically shaped to presents a substantially flat surface to the skin and space the cutting teeth a desired distance from the skin. The attachments also typically include a plurality of fins that lift the facial hair strands, or whiskers, for trimming, while channels between the fins guide the hair to the blades of the shearing device. Some attachments are shaped to space the blade of the trimmer different distances from the skin to allow the facial hair to be safely cut to two different lengths as desired by the user.

Such known attachments are, however, not adapted for safe operation of the shearing device to trim hairs inside the nose. That is because they are designed for operation of the shearing device on substantially flat surfaces of the body, such as on the face, which are obviously quite different from the inside of the nose and are too bulky for comfortable operation in the nose. Additionally, any attempt to operate a shearing device as a nose hair trimmer without an attachment to serve as a safety guide could cause the blades to come dangerously close to the skin, resulting in cuts or abrasions, damage to the skin and, extreme discomfort. There is therefore a need for a streamlined shearing device that is adapted for safe operation inside the nose, and other places where conventional trimmers do not work well. Such a shearing device should present a rounded shape to the surface, while spacing the blades a safe distance from the surface, for comfortable and convenient trimming of hair within the nose.

An object of the present invention is to provide a shearing device which can be used for safely trimming hair without the blades coming in contact with the surface being trimmed.

Another object of this invention is to provide a shearing device which spaces the blades of the trimmer from the skin during operation for trimming hair inside the nose.

### SUMMARY OF THE INVENTION

A shearing device is provided which facilitates operation of the device without damaging the surface. In a preferred embodiment, the shearing device includes a housing having a top portion and a bottom portion, the top portion having one or more openings and a plurality of ridges forming channels adjacent to the one or more openings; one or more blade members disposed in the one or more openings in the top portion of the housing; and driving means located within said housing operatively connected to one or more of said blade members. The opening in the housing provides access for the one or more blade members to cut the hair. The one or more openings can be of any shape, but is preferably oval, oblong, or rectangular. The ridges serve to separate the blade members from the skin. Preferably, the ridges are made of plastic. The cross-sectional shape of the ridges can be square, rectangular, triangular, circular, oval, or oblong. One or more of the blade members of the shearing device are formed with a plurality of teeth, which are reciprocated to shear the hair. One or more of the blade members can be reciprocated by many different driving means, including a motor, a system of one or more gears, a battery, AC connection or manual power. In one embodiment of the invention, the cutting head of the shearing device includes a single opening, and a single set of blade members. In another embodiment, the shearing device is a double-sided shearing device, which includes two openings located on opposite sides of the cutting head, and two sets of blade members.

### BRIEF DESCRIPTION OF THE DRAWINGS

FIG. 1 is a view of a first embodiment of the shearing device, showing a top portion including a cutting blade assembly for use as a shearing device according to the invention;

FIGS. 2A-D show rotated side views of the shearing device of FIG. 1;

FIGS. 3A-D are views of the cutting head of the shearing device;

FIGS. 4A and 4B show side views of a second embodiment of the shearing device, where the top portion of the shearing device includes two sets of cutting blade assemblies located on opposite sides of the cutting head;

FIGS. 5A-D show rotated side views of the top portion of the shearing device of FIGS. 4A and 4B.;

FIG. 6 illustrates a drive mechanism for driving one or more of the blade members of the shearing device.

### DESCRIPTION OF THE PREFERRED EMBODIMENTS

The present invention has been described in terms of a shearing device that provides for safely spacing the cutting blades away from a surface, and that allows operation of the device as, e.g., a nose hair trimmer. The individual cutting blades of the shearing device are referred to herein as blade members. The set of one or more blade members disposed in an opening of the cutting head is referred to herein as a cutting blade assembly. While the invention is described in terms of use for shearing hair inside the nose, there are many possible uses of the device or modification of the device that may be apparent to one of ordinary skill in the art. For example, the device can be used for shearing hair, such as from the face or ears or modified for use to remove lint and other debris from garments, or any other type of material from a surface.

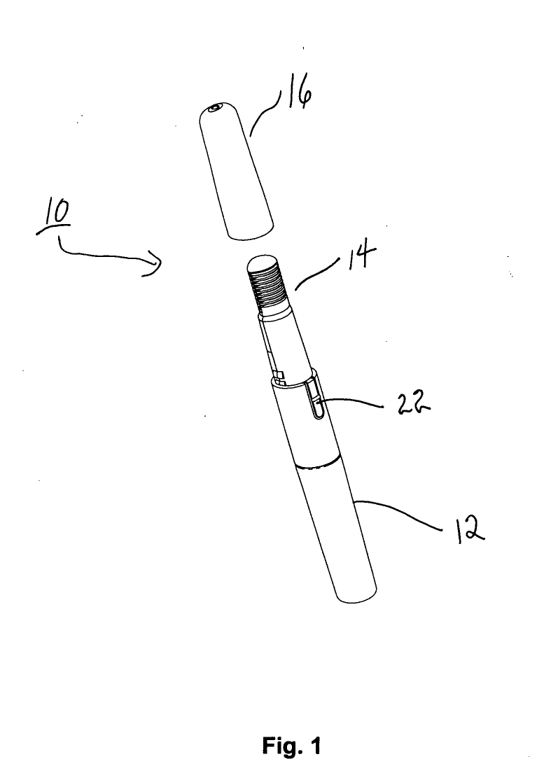

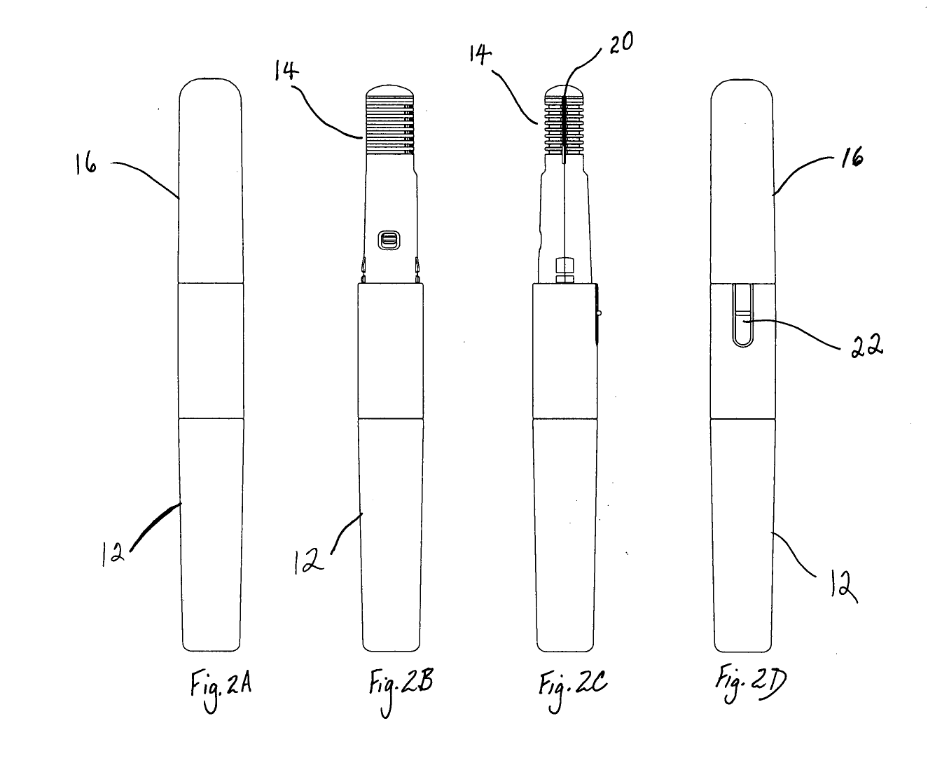

FIGS. 1 and 2A-D illustrate a first embodiment of the shearing device of the present invention. The shearing device 10 has a housing having a longitudinal axis and includes a handle 12, cutting head 14, capping member 16, and switch 22. The cutting head 14 is located at the top portion of the housing, and includes a cutting blade assembly 20 oriented along the longitudinal axis of the cutting head 34. The capping member 16 may be positioned over the cutting head 14 when the shearing device is not in use. Handle 12 is located at the bottom portion of the housing. Switch 22 located on the side of the shearing device serves to turn the device on or off.

FIGS. 2A-D show rotated views of the shearing device 10 of FIG. 1. FIGS. 2A and 2D show the shearing device including capping member 16, while in FIGS. 2B and 2C capping member 16 is absent.

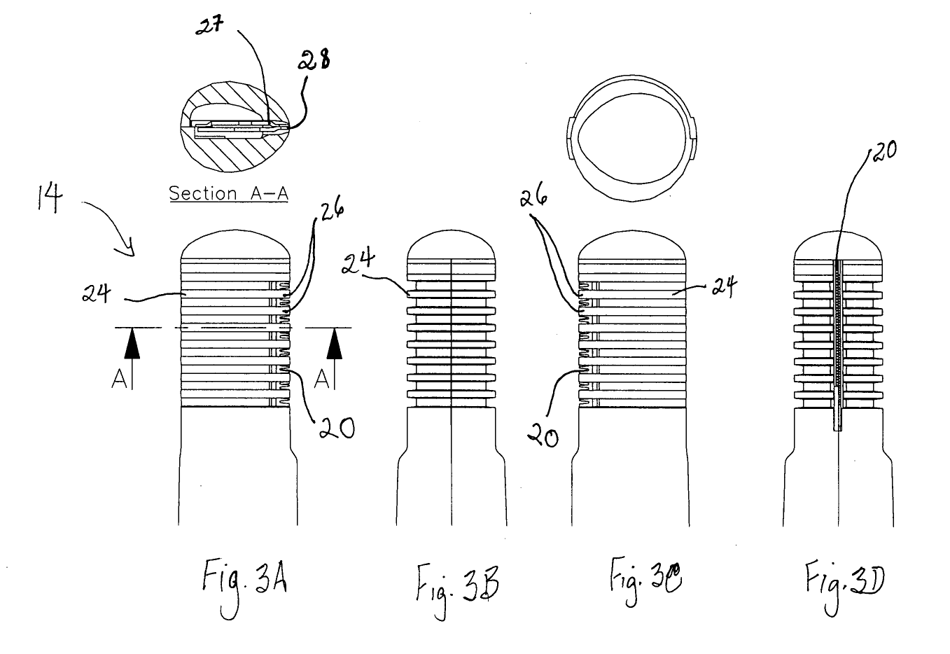

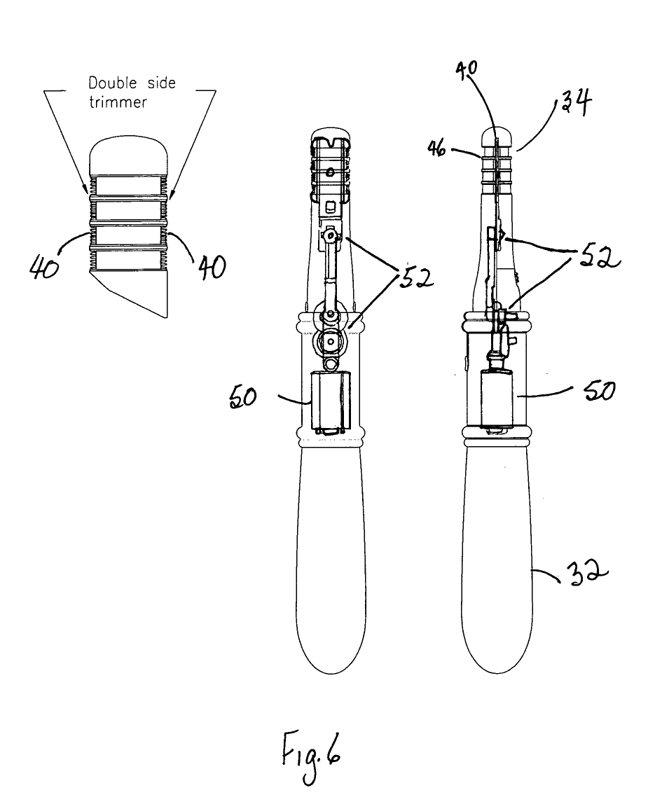

FIGS. 3A-3D illustrate the cutting head 14 of the shearing device 10 of FIG. 1. FIG. 3D shows the cutting head 14 including cutting blade assembly 20 oriented along the longitudinal axis of the cutting head 14. The cutting blade assembly 20 includes at least one blade member positioned within the housing. In one embodiment of the invention, cutting blade assembly 20 includes at least two blade members 27 and 28 (see FIG. 3A). In an embodiment of the invention, at least one blade member of the cutting blade assembly is stationary, while one or more of the other blade members is capable of moving in a reciprocating fashion. In another embodiment, all of the two blade members of a cutting blade assembly are both capable of moving in a reciprocating fashion relative to one another. The one or more blade members capable of moving are connected to driving means located within the housing, which is capable of causing the blade members to move in a fashion reciprocating relative to each other or the housing. FIG. 6 illustrates a driving means for driving one or more of the blade members of the shearing device. The driving means can be electrically powered or manually powered, and can include a motor 50, a system of gears 52, one or more batteries (not shown) and/or AC connectivity (not shown).

One or more of the blade members are formed with a plurality of teeth. The reciprocating motion of the blade members causes the teeth of adjacent blade members to cross back and forth, which provides for the shearing of, e.g., hair. When a hair strand enters the area of the cutting blade assembly 20, the teeth of one or more of the reciprocating blade members pass across the spaces between the teeth of another blade member, engaging the hair strand and shearing it.

A plurality of ridges 26 and opening 29 in cutting head 14 form a plurality of channels that serve to expose the teeth of the blade members of the cutting blade assembly 20. The ridges 26 extend to opening 29 centered around the cutting blade assembly 20, and bracket on either side of the teeth of the blade members. In one embodiment, the opening runs the entire length of the cutting blade assembly 20. In the exemplary embodiment of FIGS. 3A and 3C, the width of the channels are such that a number of the teeth of the blade members of the cutting blade assembly 20 are exposed during operation to cut hair. Opening 29 around the cutting blade assembly 20 can be rectangular, oval, oblong, or other shapes.

The ridges 26 also serve to space the blade members of the shearing device a safe distance from the surface, which is beneficial during operation of the device for removing hair from sensitive areas, e.g., from within the nose. The ridges 26 significantly reduces the risk of cutting or abrading skin, effectively eliminating the risk of damage or discomfort. The length of the hairs remaining after shearing is determined primarily by the depth of the ridges 26 adjacent the opening. For example, the hairs can be trimmed to relatively long lengths if ridges 26 adjacent the opening are relatively deep. If the ridges 26 adjacent the opening are made shallower, the hair can be trimmed to relatively short lengths. The optimal thickness of the ridges 26 in the region of the opening depends on various factors, such as the minimal desired safe distance maintained between the blade members and the skin, the length the teeth of the blade members, the desired length of the trimmed hair, and the strength of the material forming the ridges 26. Desired lengths of trimmed hairs in the nose are typically between 0.020 inches and 0.040 inches, although other thicknesses between about 0.010 inches and 0.125 inches are contemplated and the invention is not limited by the length of the trimmed hair. In one embodiment, the depth of the ridges 26 in the region of the opening is approximately the length of the teeth of the one or more blade members of the cutting blade assembly 20. In other embodiments, the depth of the channels between ridges is also the length of the teeth of the one or more blade members of the cutting blade assembly 20.

In the exemplary embodiment of FIGS. 3A-D, the ridges 26 extend about the circumference to become ridges 24 on an opposite face of the cutting head 14. In other embodiments, the ridges 26 are formed only near the opening, and the surface of the cutting head away from the opening is substantially smooth, i.e., ridges 24 are absent. In the different embodiments of the invention, the extent of the indentations formed by ridges 26 about the cutting head 14 varies according to the choice of design. The ridges can have many different cross-sectional shapes, such as square, rectangular, triangular, circular, oval, oblong, or other shapes. Additionally, while the ridges 24 or 26 are illustrated in FIGS. 3A-D as running at an angle of 90° to the longitudinal axis of the housing, i.e., in a circular pattern, in other embodiments the ridges can be oriented at other angles to the housing. For example the ridges can be patterned in a “V” shape relative to said opening. In another embodiment, ridges 24 or 26 are oriented on a helical pattern relative to the housing.

In many embodiments, the ridges 24 and 26 are formed integral with, and are non-removable from the top portion of the housing of the shearing device. However, in other embodiments, the ridges 24 and 26 may be formed on a body which serves as a removable attachment to a shearing device in which the blade members are otherwise unshielded or unprotected. Such a removable attachment could slips over the cutting head 14 of the shearing device 10 and can be secured to the trimmer by means known in the art.

In one embodiment, the ridges 24 and 26 are formed of a smooth, resilient material, such as a plastic. Such a material would presents little or no friction to the skin, which would significantly reduce or prevents any pulling on the skin. In embodiments of the shearing device including a removable attachment, the attachment is formed from a pliable material for easy placement over the cutting blade assembly 20. In embodiments where the ridges 26 are fixed to the cutting head 14, the material may be less pliable, such that the ridges 26 and channels are fairly sturdy and do not bend or break easily.

The shearing device 10 of the present invention can be operated in any manner desired by the user. For example, the rounded smooth head of the shearing device illustrated in FIGS. 1-3D allows for operation as a nose hair trimmer. In operation, one or more of the blade members of the cutting blade assembly 20 is reciprocated relative to each other or the housing while the shearing device 10 is brought in contact with the hair within the nose. The shearing device can be rotated during operation. As the ridges 26 serve to safely space the cutting blade assembly 20 away from the skin, the cutting head 14 of the shearing device 10 can also be brought in direct contact with the skin during operation.

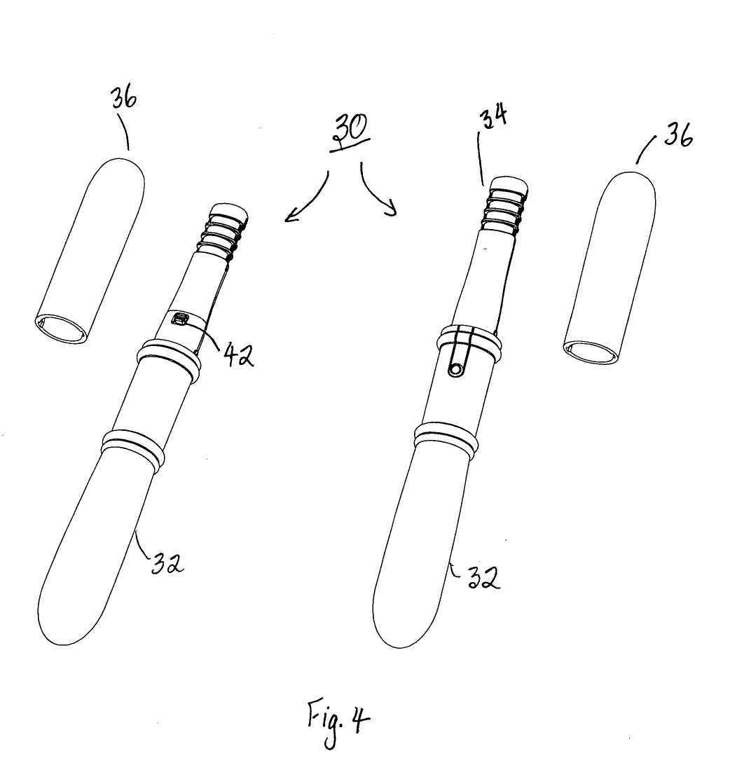

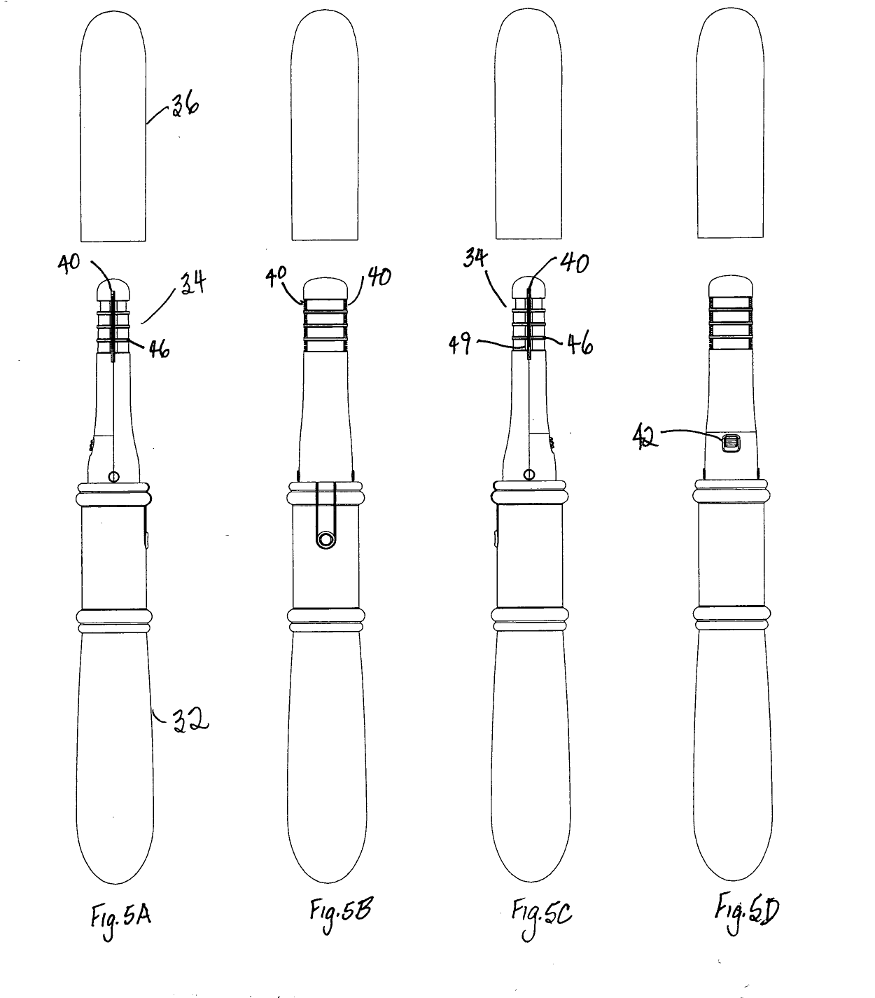

FIGS. 4, 5A-D and 6 illustrate a second embodiment of the shearing device of the present invention. The shearing device 30 has a housing having a longitudinal axis and includes a handle 32, cutting head 34, capping member 36, and switch 42. The cutting head 34 is located at the top portion of the housing, and includes two sets of cutting blade assemblies 40. Each cutting blade assembly 40 is located on opposite sides of the cutting head and is oriented along the longitudinal axis of the cutting head 34. Cutting blade assembly 40 can include one or more blade members. The capping member 36 may be positioned over the cutting head 34 when the shearing device is not in use. Handle 32 is located at the bottom portion of the housing. Switch 42 located on the side of the shearing device turns the device on or off.

FIGS. 5A-D show rotated views of the cutting head 34 of the shearing device 30 of FIG. 4. FIGS. 5A and 5C show opposite sides of the cutting head 34, where each side includes a cutting blade assembly 40 oriented along the longitudinal axis of the cutting head 34. Cutting blade assembly 40 includes at least one blade member positioned within the housing. In the illustration of FIGS. 5A and 5C, cutting blade assembly 40 includes two blade members. In other embodiments, cutting blade assembly 40 includes more than two blade members. In a specific embodiment, at least one blade member is stationary, while one or more of the other blade members move in a reciprocating fashion. In another embodiment, all of the one or more blade members are both capable of moving in a reciprocating fashion relative to each other. The driving means operatively connected to one or more of the blade members has been previously described.

Cutting head 34 includes two openings 49, located on opposite sides of the cutting head 34. Openings 49 are centered about the two cutting blade assemblies 40, and expose the teeth of the one or more blade members of the cutting blade assemblies 40. A plurality of ridges 46 form a plurality of channels about the cutting blade assemblies 40. The ridges 46 extend to the openings 49, and bracket either side of the teeth of the blade members of the cutting blade assemblies 40. In one embodiment, the openings 49 run the entire length of the cutting blade assembly 40. In the illustration of FIGS. 5B and 5D, the width of the channels are such that a number of the teeth of the blade members of the cutting blade assembly 40 are exposed. The openings 49 around cutting blade assembly 40 can be rectangular, oval, oblong, or other shapes.

Applications of the present invention include for example safe trimming of hair from the skin of the face, ear, nose, neck or other portions of the body without risk of abrading or damaging the skin.

While the principles of the invention have been described above in connection with specific apparatus and applications, it is to be understood that this description is made only by way of example and not as a limitation on the scope of the invention.

1. An shearing device, comprising:
a housing having a top portion and a bottom portion, wherein the top portion having one or more openings and a plurality of ridges forming channels adjacent to the one or more openings;
one or more blade members disposed in the one or more openings; and
driving means located within said housing operatively connected to at least one of said one or more blade members.

2. The shearing device of claim 1, wherein said ridges are made of plastic.

3. The shearing device of claim 1, wherein said one or more or said blade members comprise a plurality of teeth.

4. The shearing device of claim 3, wherein the depth of the channels formed by the ridges is the length of the teeth of the one or more blade members.

5. The shearing device of claim 3, wherein the depth of the channels formed by the ridges is greater than the length of the teeth of the one or more blade members.

6. The shearing device of claim 3, wherein the depth of the channels formed by the ridges is less than the length of the teeth of the one or more blade members.

7. The shearing device of claim 1, wherein said one or more openings are one of oval, oblong, or rectangular.

8. The shearing device of claim 1, wherein a cross-sectional shape of said ridges is one of square, rectangular, triangular, circular, oval, or oblong.

9. The shearing device of claim 1, wherein said ridges are oriented at an angle of 90° to a longitudinal axis of the housing.

10. The shearing device of claim 1, wherein said ridges are oriented at an angle of other than 90° to a longitudinal axis of the housing.

11. The shearing device of claim 1, wherein said ridges form a helical pattern around said housing.

12. The shearing device of claim 1, wherein said ridges form a “V” shape relative to said one or more openings.

13. The shearing device of claim 1, wherein said driving means is electrically powered.

14. The shearing device of claim 14, wherein said driving means comprises a motor, one or more gears, a battery or an AC connection.

15. The shearing device of claim 1, wherein said driving means is manual power.

16. The shearing device of claim 1, wherein the top portion comprises one opening.

17. The shearing device of claim 1, wherein the top portion comprises two openings.

18. The shearing device of claim 17, wherein the two openings are located on opposite sides of the top portion.

19. The shearing device of claim 1, wherein one blade member is disposed in each of said one or more openings.

20. The shearing device of claim 1, wherein two or more blade members are disposed in each of said one or more openings.

21. The shearing device of claim 1, wherein two blade members are disposed in said one or more openings, and wherein said driving means drives both of said blade members.

22. The shearing device of claim 1, wherein two blade members are disposed in each of said one or more openings, and wherein one of said blade members is stationary and the driving means drives the other blade member.
